(19) United States
(12) Patent Application Publication
(10) Pub. No.: US 2024/0342818 A1
(43) Pub. Date: Oct. 17, 2024

(54) ADAPTIVE TWIN CONSUMABLE WELDING

(71) Applicant: The ESAB Group, Inc., North Bethesda, MD (US)

(72) Inventors: Zeljko Ackar, Partille (SE); Edwin Bergstedt, Trollhattan (SE)

(21) Appl. No.: 18/298,502

(22) Filed: Apr. 11, 2023

(51) Int. Cl. B23K 9/12; B23K 9/18

(52) U.S. Cl. CPC B23K 9/122; B23K 9/124; B23K 9/188

(57) ABSTRACT

A contact device for a welding apparatus is disclosed. The contact device is for providing current to a first welding wire and a second welding wire. The contact device includes first and second contact jaws. The first and second contact jaws include a plurality of longitudinally extending grooves formed therein that form passageways for the welding wires. The welding wires can be positioned in a first configuration in which they are spaced apart and in a second configuration in which they are next to and contact each other.

### FIELD OF THE DISCLOSURE

The present invention relates to welding, and more specifically, to a contact device for a submerged arc welding system and process, the contact device supplying two welding wires through the contact device to the welding puddle.

### BACKGROUND

Submerged arc welding (SAW) is a welding method characterized by high productivity and quality, often used for longer welding seams in thicker materials. It is well known in a SAW process to use a consumable electrode or wire (e.g., a welding wire) to conduct a weld current through a work piece. In a SAW process, the electric current is passed from the weld head to the wire using copper contact jaws. The weld current forms an arc between the welding wire and the work piece to melt the wire and create a weld puddle on the work piece. This welding wire is generally referred to as a hot wire.

SAW is often characterized in that the melted material and the arcs are protected beneath a layer of pulverized flux. The flux melts in part during the welding process, thus creating a protective layer of slag on the weld puddle. Fluxes used in SAW may be granular fusible minerals typically containing oxides of manganese, silicon, titanium, aluminum, calcium, zirconium, magnesium and other compounds, such as calcium fluoride. The flux may be specially formulated to be compatible with a given welding wire type so that the combination of flux and wire yields desired mechanical properties. During use, the flux reacts with the weld puddle to produce a weld metal chemical composition and resulting mechanical properties. It is common practice to refer to fluxes as “active” if they add manganese and silicon to the weld. The amount of manganese and silicon added may be influenced by the arc voltage and the welding current level.

It is desirable to increase the productivity of a SAW process. One way to accomplish this is to increase the weld speed and the deposition rate (e.g., the rate at which weld metal is actually deposited onto the work piece surface). One way to increase the deposition rate is to use multiple hot wires in a single weld puddle. For example, two hot wires may be used, however, usage of more hot wires is known. Using more than one hot wire in a single weld puddle enables increased deposition rates and therefore improves the economy of the welding process.

Two exemplary welding processes are “twin” welding and “tandem” welding. A “twin” welding process involves two wires located in the same weld head that uses one power supply. A “tandem” welding process utilizes two weld heads with independent power sources that can be controlled independent of each other. In connection with twin hot wires, it has proven advantageous to use two hot wires which are fed forward to the welding puddle thru a common contact device. In one embodiment, a single power source may be coupled to the contact device for distributing power to the two hot wires. With this method, more material is provided to the welding joint and increases the co-efficient of fullness or volume expansion in the joint. The coefficient of fullness is usually measured with the so-called deposition rate.

Generally, SAW can be performed with single wire contact jaws or twin wire contact jaws. A twin wire jaw has two grooves for receiving two wires, while a single wire jaw has a single groove for receiving a single wire. The contact jaws conduct current from the power supply to the weld wire(s). Typically, single wire SAW uses low currents, while twin wire SAW uses high currents.

The hot wires can be arranged in various settings or formations. For instance, in a “twin” process, the hot wires can be positioned in transverse relation (i.e., perpendicular to a welding direction), or they may be positioned in longitudinal relation (i.e., parallel to or collinear with the welding direction), or a combination thereof. Two hot wires can be positioned in transverse relation, and in this arrangement, they may be used for surface welding or specific joints where a wide joint is desired. This welding arrangement generally leads to lower penetration and greater width. Where the two hot wires are positioned at a longitudinal distance from each other with respect to the welding direction, the first hot wire in the direction of welding is normally referred to as a leading hot wire and the second hot wire, located behind the leading hot wire, is normally referred to as a trailing hot wire. Normally, in a “tandem” welding process, the leading hot wire and the trailing hot wires serve different roles in the welding process. It is for instance known to control the leading hot wire such that a desired degree of penetration is obtained, whereas the trailing hot wire controls weld bead appearance, contour and fill.

Single wire SAW is useful in root passes of a weld but cannot handle high currents, limiting a deposition rate and, thus, weld speed. Meanwhile, twin wire SAW has a high deposition rate and can handle high currents and, thus, weld speed, but is usually not suitable for a root pass of the weld seam. Moreover, operating a twin wire SAW at low current negatively impacts the weld bead geometry. Further, weld heads for twin wire SAW are more complex resulting in cumbersome and time consuming setup. Typically, a user performs the root pass using a single wire SAW, then reconfigures the system for subsequent passes using twin wire SAW, resulting in lost production time.

Thus, there is a need for a contact device that is easy to use for a root pass and for subsequent passes in the welding process. There is also a need for a contact device that is easily reconfigurable between a different operating configurations, such as an operating configuration for root passes and an operating configuration for subsequent passes.

### SUMMARY

This summary is provided to introduce a selection of concepts in a simplified form that are further described below in the detailed description. This Summary is not intended to identify key features or essential features of the claimed subject matter, nor is it intended as an aid in determining the scope of the claimed subject matter.

In one embodiment of a contact device according to the present invention, the contact device for providing current to at least a first welding wire and a second welding wire, the contact device comprises a first contact jaw having an inner surface defining a plurality of grooves, and a second contact jaw, wherein the plurality of grooves of the first contact jaw includes a first pair of grooves and a second pair of grooves different from the first pair of grooves, and each of the plurality of grooves on the first contact jaw is sized so that it can receive a welding wire.

In one embodiment, the second contact jaw has an inner surface defining a plurality of grooves, and each of the grooves of the second contact jaw being aligned with one of the grooves of the first contact jaw when the first contact jaw inner surface is proximate to the second contact jaw inner surface. In another embodiment, the grooves in the first pair of grooves on the first contact jaw are proximate to each other. Additionally, the first pair of grooves on the first contact jaw is located between the second pair of grooves on the first contact jaw.

In another embodiment, each of the grooves in the second pair of grooves on the first contact jaw is spaced a first distance from an outer side surface of the first contact jaw, each of the grooves in the first pair of grooves is spaced a second distance from an outer surface of the first contact jaw, and the first distance is smaller than the second distance.

In yet another embodiment, the first contact jaw includes a first end and a second end opposite to its first end, each of the grooves in the first contact jaw extends from the first contact jaw first end to the first contact jaw second end, the first pair of grooves in the first contact jaw are an inner pair of grooves, the second pair of grooves in the first contact jaw are an outer pair of grooves, and the inner pair of grooves are located between the outer pair of grooves. Alternatively, the first contact jaw includes a plurality of tapered surfaces formed in its first end, the plurality of tapered surfaces include a first tapered surface in communication with a first groove of the outer pair of grooves, a second tapered surface in communication with a second groove of the outer pair of grooves, and a third tapered surface in communication with both grooves of the inner pair of grooves.

In another embodiment, the first contact jaw includes a notch formed therein, the second contact jaw includes a projection extending therefrom, and the projection engages the notch when the first contact jaw is proximate to the second contact jaw.

In another embodiment of a contact device according to the present invention, the contact device for providing current to a first welding wire and a second welding wire, the contact device having a first operating configuration and a second operating configuration different from the first operating configuration, the contact device comprises a first contact jaw having an inner surface defining a first pair of grooves and a second pair of grooves, and a second contact jaw having an inner surface defining a first pair of grooves and a second pair of grooves, wherein when the inner surface of the first contact jaw is proximate to the inner surface of the second contact jaw, the first pairs of grooves are aligned with each other and form a first pair of passageways along the first contact jaw and the second contact jaw, and the second pairs of grooves are aligned with each other and form a second pair of passageways along the first contact jaw and the second contact jaw, and in the first operating configuration the first welding wire and the second welding wire are disposed in the first pair of passageways, and in the second operating configuration the first welding wire and the second welding wire are disposed in the second pair of passageways.

In one embodiment, the passageways in the first pair of passageways are proximate to each other. In another embodiment, the passageways in the first pair of passageways are located between the passageways in the second pair of passageways. In yet another embodiment, each of the passageways in the second pair of passageways is spaced a first distance from an outer side surface of the contact jaws, each of the passageways in the first pair of passageways is spaced a second distance from an outer side surface of the contact jaws, and the first distance is smaller than the second distance.

In another embodiment, the grooves in the first contact jaw are parallel to each other and extend from a first end of the first contact jaw to a second end of the first contact jaw, the grooves in the second contact jaw are parallel to each other and extend from a first end of the second contact jaw to a second end of the second contact jaw, and each of the grooves in the first contact jaw is aligned with one of the grooves in the second contact jaw when the first contact jaw and the second contact jaw are proximate to each other.

Alternatively, the first welding wire and the second welding wire can be moved from the first pair of passageways to the second pair of passageways when the first contact jaw is spaced apart from the second contact jaw. In another embodiment, the first welding wire and the second welding wire are adjacent to and contact each other when they are in the first pair of passageways in the first operating configuration.

In another embodiment of a contact device according to the present invention, a method of welding using a contact device for providing current to a first welding wire and a second welding wire, the contact device including a first contact jaw and a second contact jaw, the first contact jaw and the second contact jaw defining therebetween a first pair of passageways and a second pair of passageways, the contact device having a first operating configuration and a second operating configuration, the method comprises placing the contact device in the first operating configuration, providing current to the first welding wire and the second welding wire, moving the first contact jaw away from the second contact jaw to access the first welding wire and the second welding wire, placing the contact device in the second operating configuration, and providing current to the first welding wire and the second welding wire.

In an alternative embodiment, the step of placing the contact device in the first operating configuration includes positioning the first welding wire and the second welding wire in the first pair of passageways. In another embodiment, the step of placing the contact device in the second operating configuration includes moving both of the first welding wire and the second welding wire to the second pair of passageways. In yet another embodiment, the placing the contact device in the first operating configuration results in the first welding wire and the second welding wire being proximate to and contacting each other. Alternatively, the placing the contact device in the second operating configuration results in the first welding wire and the second welding wire being spaced apart from each other.

### BRIEF DESCRIPTION OF THE DRAWINGS

By way of example, a specific embodiment of the disclosed invention is now described with reference to the accompanying drawings.

FIG. 1 is a perspective view illustrating an embodiment of an exemplary SAW process utilizing a contact device according to the present invention.

FIG. 2 is top perspective view of the contact device illustrated in FIG. 1.

FIG. 3 is a plan view of an embodiment of a contact jaw according to the present invention.

FIG. 4 is a side view of a pair of contact jaws according to the present invention.

FIG. 5 is an inner side view of one of the contact jaws illustrated in FIG. 4.

FIG. 6 is a perspective view of the contact jaws illustrated in FIG. 4 in spaced apart positions.

FIG. 7 is a top view of the top ends of the contact jaws illustrated in FIG. 4.

FIG. 8 is a bottom view of the bottom ends of the contact jaws illustrated in FIG. 4.

FIG. 9 is a perspective view of a portion of one of the contact jaws illustrated in FIG. 4.

FIG. 10 is a perspective view of the contact jaws illustrated in FIG. 4 with the welding wires in spaced apart positions.

FIG. 11 is a perspective view of the contact jaws illustrated in FIG. 10 with the welding wires in proximate positions.

FIG. 12 is a close-up front view of the contact jaws with welding wires in a first configuration.

FIG. 13 is a close-up front view of the contact jaws with welding wires in a second configuration.

FIG. 14 illustrates views showing the relative depths that a pair of welding wires and a single wire can achieve.

FIG. 15 illustrates images from bead on plate testing of a single 4.0 mm wire compared to 2×2.0 mm wires used according to the present invention.

FIG. 16 illustrates images from bead on plate testing of 2×2.0 mm wires in first and second configurations according to the present invention.

### DETAILED DESCRIPTION

Embodiments of a contact device in accordance with the present invention are described more fully herein with reference to the accompanying drawings, in which preferred embodiments of the present disclosure are presented. The following disclosure is intended to provide illustrative embodiments of the disclosed apparatus and these exemplary embodiments should not be interpreted as limiting. The contact device of the present disclosure may, however, be embodied in many different forms and should not be construed as being limited to the embodiments set forth herein. Rather, these embodiments are provided so that this disclosure will convey certain exemplary aspects of the contact device to those skilled in the art. In the drawings, like numbers refer to like elements throughout unless otherwise noted. One of ordinary skill in the art will understand that the steps and methods disclosed may easily be reordered and manipulated into many configurations, provided they are not mutually exclusive.

As described in greater detail below, the contact device of the present invention allows for welding with contact jaws that are capable of contacting and guiding two consumable wires with different lateral offsets or positions. The system including and the methods of using contact jaws according to the present invention enables a user to operate the contact head in two modes. A first mode is a regular twin mode or configuration in which welding wires are held by the contact jaws in spaced apart positions. A second mode is a force single mode or configuration in which welding wires are adjacent to and in contact with each other. The contact head disclosed herein utilizes a contact jaw arrangement that enables twin and force single modes of welding in the same contact jaw arrangement. In the force single mode, the two welding wires are forces together, which results in those wires acting as a single wire. This provides the opportunity to weld with the benefits of a single wire in a twin wire setup.

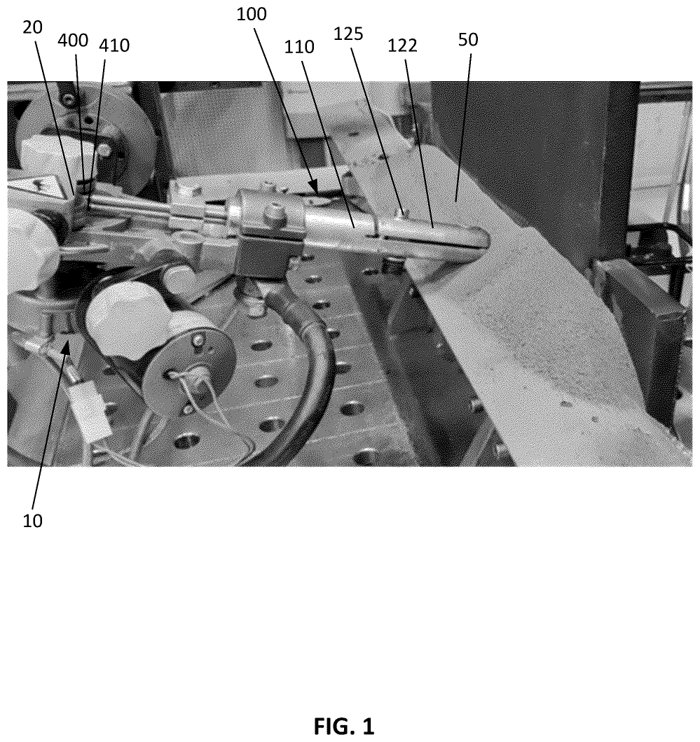

Referring to FIG. 1, a perspective view illustrating an embodiment of an exemplary SAW process utilizing a contact device according to the present invention is shown. In this embodiment, a welding system 10 includes a wire feeding mechanism 20 that supplies or feeds welding wires 400 and 410 to a welding contact device 100. In this embodiment, the contact device 100 is used in a SAW process as illustrated, and the device 100 may be configured so that at least two welding wires 400 and 410 may be received therein and fed therethrough to the welding puddle. The welding wires 400 and 410 may be connected to a single power source (not shown). The welding wires 400 and 410 may be fed forward through first and second contact jaws (described below) in a parallel relationship with respect to one another, although this is not critical and the wires may be fed at an oblique angle with respect to each other.

The distal tip or end of the contact device 100 is positioned within flux 50. The contact device 100 includes a contact tube or weld head 110 to which a contact bracket 122 can be secured via a fastener 125, such as a threaded bolt.

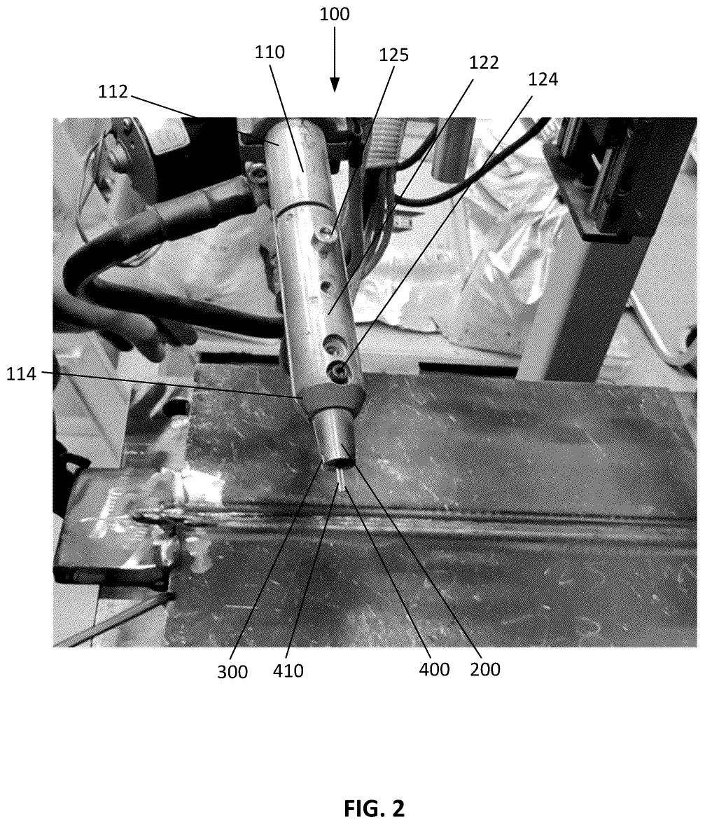

Referring to FIG. 2, a top perspective view of the contact device 100 is illustrated. The contact tube 110 has a first or proximal end 112 and a second or distal end 114. At the second end 114 of the contact tube 110, the contact tube 110 may have a generally cylindrical or tubular shape, although other shapes are envisioned. Similarly, at the first end 112, the contact tube 110 may have a semi-circular or semi-tubular shape, although other shapes are envisioned.

The first end 112 of the contact tube 110 may be arranged and configured to receive a contact bracket 122. As shown, the contact bracket 122 may have a semi-cylindrical or semi-tubular shape to mate with the first end 112 of the contact tube 110 to form a cylindrical configuration. The contact device 100 includes a pair of adaptive twin SAW contact jaws that can be quickly configured between two modes, as described below. A first contact jaw 200 may be coupled to the contact bracket 122, which is removably coupled to the first end 112 of the contact tube 110. A second contact jaw 300 may be coupled to the contact tube 110 at the first end 112 thereof. Located between the first contact jaw 200 and the second contact jaw 300 are welding wires 400 and 410.

In use, the contact bracket 122 may be removably coupled to the contact tube 110 by any mechanism or coupling object. For example, as shown, the first end 112 of the contact tube 110 and the contact bracket 122 may include one or more holes for receiving a fastener 125 such as, for example, a threaded nut and bolt.

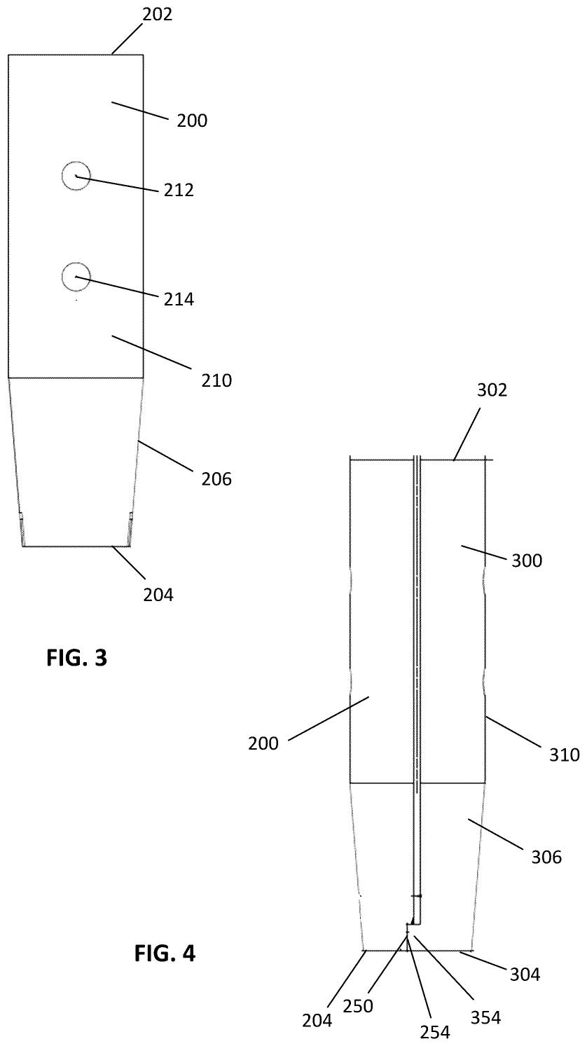

Referring to FIG. 3, a plan view of an embodiment of one of the contact jaws according to the present invention is illustrated. In this view, only contact jaw 200 is shown. Contact jaw 200 has a first end 202 and an opposite second end 204. The portion of contact jaw 200 at the second end 204 has a slightly tapered outer configuration 206. The contact jaw 200 has an outer or exterior surface 210 through which holes 212 and 214 pass through the contact jaw 210.

Referring to FIG. 4, a side view of an embodiment of contact jaws according to the present invention is illustrated. Contact jaw 200 includes a surface 240 that defines a notch 244 that is described in greater detail below. In this view, some of the features of contact jaw 300 are visible. Contact jaw 300 includes a first end 302 and an opposite second end 304. Proximate to second end 304 is a tapered portion 306, which has a tapered configuration that matches tapered portion 206 on contact jaw 200. Contact jaw 300 includes an outer or exterior surface 310 similar to exterior surface 210 of contact jaw 200. Proximate to second end 304 is a projection 354 that engages the notch 254 of contact jaw 200 when the contact jaws 200 and 300 are placed proximate to each other.

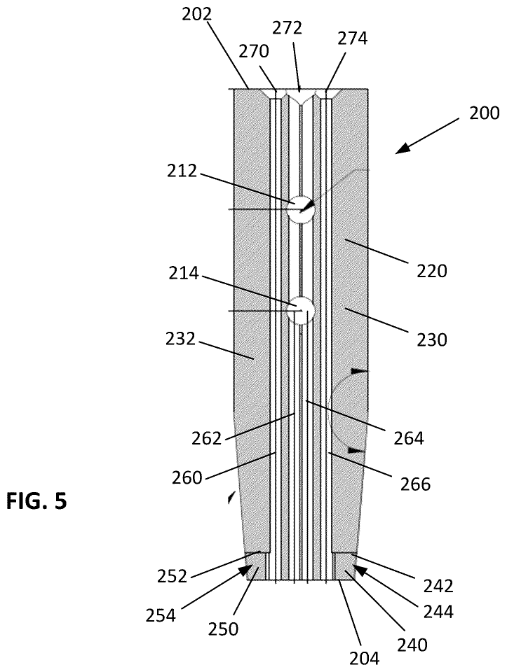

Referring to FIG. 5, an inner side view of contact jaw 200 is illustrated. In this embodiment, contact jaw 200 has an inner surface 220 that extends from first end 202 to second end 204. Through holes 212 and 214 extend from the outer surface 210 to the inner surface 220. In the illustrated embodiment, through holes 212 and 214 are threaded. However, in an alternative embodiment, the holes 212 and 214 may not include threads. Holes 212 and 214 are formed to engage the contact tube 110 and the contact bracket 122, such as via one or more fasteners 124 (see FIG. 2) extending thru the openings 212 and 214. The inner surface 220 includes opposite side portions 230 and 232 between which are several grooves formed in the inner surface 220.

The interior surface 220 of the first contact jaw 200 includes longitudinally extending grooves for receiving and guiding the welding wire therethrough. In this embodiment, the inner surface 220 includes four grooves 260, 262, 264, and 266, each of which extend from first end 202 to second end 204. Each of the grooves 260, 262, 264, and 266 is sized to receive and guide a welding wire therein. In one embodiment, each of the grooves is sized to receive a 2.0 mm diameter welding wire. Grooves 262 and 264 form an inner pair of grooves and grooves 260 and 266 form an outer pair of grooves. When welding wires 400 and 410 are placed in the inner pair of grooves 262 and 264, the wires 400 and 410 contact each other and function in a force single mode as a single wire that has a 4 mm length but only a 2 mm diameter in the other direction. When welding wires 400 and 410 are placed in the outer pair of grooves 260 and 266, the wires 400 and 410 are spaced apart from each other and function in a twin wire mode as two separate wires.

As shown in FIG. 5, the interior surface 220 of the first and second contact jaw 200 includes several tapered surfaces adjacent the first end 202 thereof. In this embodiment, tapered surfaces 270 and 274 are located at the end of grooves 260 and 266, respectively. In addition, a single tapered surface 272 is located at the end of grooves 262 and 264. By providing the internal tapered surfaces 270, 272, and 274 at the first end 202 of the first contact jaw 200, the device is better able to minimize or eliminate wire shavings from the surfaces of the welding wires 400 and 410 entering the grooves 260, 262, 264, and 266.

Each of the grooves 260, 262, 264, and 266 may be in the form of a semi-cylindrical groove. As mentioned, contact between the welding wires 400 and 410 and the contact jaws 200 and 300 may occur at the second ends 204 and 304 of the first and second contact jaws 200 and 300, respectively, so that the stability of the system is maintained.

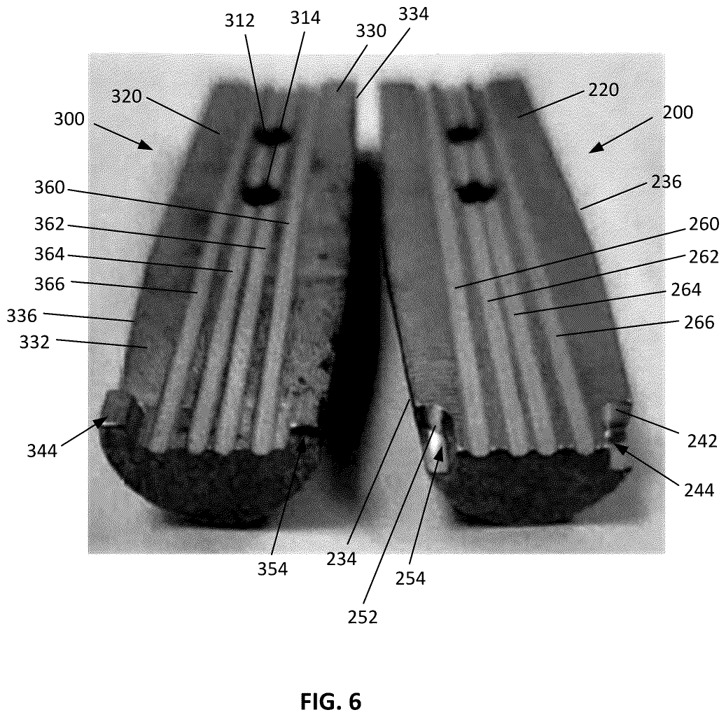

While the foregoing discussion relating to FIG. 5 has been focused on contact jaw 200, it is to be understood that contact jaw 300 includes similar features as contact jaw 200. The one unique feature for contact jaw 200 as compared to contact jaw 300 is located at each corner of the inner surface 220 at the second end 204. As shown, surfaces 240 and 242 define a notch 244 and surfaces 250 and 252 define a notch 254. The function of notches 244 and 254 are discussed below with respect to FIG. 6.

Turning to FIG. 6, a perspective view of contact jaws 200 and 300 in spaced apart positions is illustrated. In this view, the longitudinally extending grooves 260, 262, 264, and 266 formed in inner surface 220 are illustrated. The contact jaw 200 includes opposite outer side surfaces 234 and 236. As discussed above, grooves 262 and 264 are an inner or interior pair or set of grooves, and grooves 260 and 266 are an outer or exterior pair or set of grooves. Each of grooves 260 and 266 is closer to a respective one of the outer side surfaces 234 and 236 than grooves 262 and 264 are.

In particular, each of the outer grooves 260 and 266 is spaced a first distance from the closer one of the outer sides 234 and 236 of contact jaw 200. Similarly, each of the outer grooves 360 and 366 is spaced a first distance from the closer one of the outer sides 334 and 336 of contact jaw 300. In this embodiment, the first distance for grooves 260 and 266 is the same as the first distance for grooves 360 and 366. In addition, each of the inner grooves 262 and 264 is spaced a second distance from the closer one of the outer sides 234 and 236 of contact jaw 200. Similarly, each of the inner grooves 360 and 366 is spaced a second distance from the closer one of the outer sides 334 and 336 of contact jaw 300. In this embodiment, the second distance for grooves 262 and 264 is the same as the second distance for grooves 362 and 364. As shown in FIG. 6, the first distances for grooves 260 and 264 and for grooves 360 and 364 is smaller than the second distances for grooves 262 and 264 and for grooves 362 and 364.

Contact jaw 300 has similar structures and features to contact jaw 200. As shown, contact jaw 300 includes through holes 312 and 314 and an inner surface 320 with several longitudinally extending grooves 360, 362, 364, and 366 formed therein. In the illustrated embodiment, through holes 312 and 314 are threaded. However, in an alternative embodiment, the holes 312 and 314 may not include threads. Grooves 360, 362, 364, and 366 are aligned with grooves 260, 262, 264, and 266, respectively, when the contact jaws 200 and 300 are proximate to and engage each other.

The inner surface 320 of contact jaw 300 has side portions 330 and 332 that have outer edge surfaces 334 and 336, respectively. When the contact jaws 200 and 300 are placed into contact with each other, side portions 330 and 230 engage each other and side portions 332 and 232 engage each other. In addition, the projections 344 and 354 on contact jaw 300 engage notches 244 and 254, respectively, when contact jaws 200 and 300 engage each other.

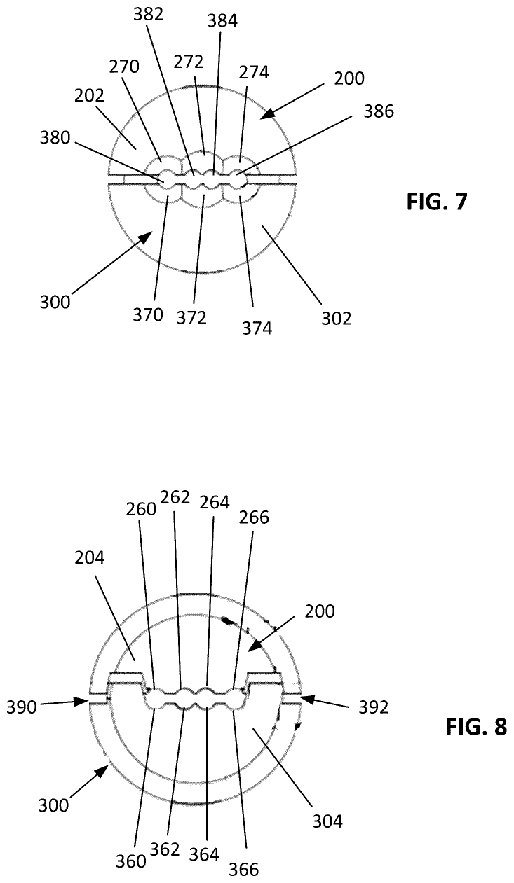

Referring to FIGS. 7 and 8, views of the top ends and of the bottom ends, respectively, of contact jaws 200 and 300 are illustrated. When contact jaws 200 and 300 engage each other, grooves 260, 262, 264, and 266 are aligned with grooves 360, 362, 364, and 366, respectively. Grooves 260 and 360 form passageway 380, grooves 262 and 362 form passageway 382, grooves 264 and 364 form passageway 384, and grooves 266 and 366 form passageway 386. At the entrance to passageway 380 are tapered surfaces 270 and 370 on contact jaws 200 and 300, respectively. Similarly, at the entrance to passageway 386 are tapered surfaces 274 and 374. Also at the entrance to passageways 382 and 384 are tapered surfaces 272 and 372. When the contact jaws 200 and 300 are engaged with each other, gaps 390 and 392 (see FIG. 8) are formed between them.

As seen best in FIGS. 7 and 8, passageway 380 is spaced from passageway 382 a first distance and passageway 386 is spaced from passageway 384 the same first distance. However, passageway 382 is spaced from passageway 384 a second distance, which is less than the first distance. The smaller distance between passageways 382 and 384 enables welding wires 400 and 410 in passageways 382 and 384 to contact each other. In this embodiment, the diameter of each of the inner grooves is slightly smaller than the lateral offset distance between their respective central axes. That is, the grooves are arranged such that the lateral sides of the wires 400 and 410 contact each other.

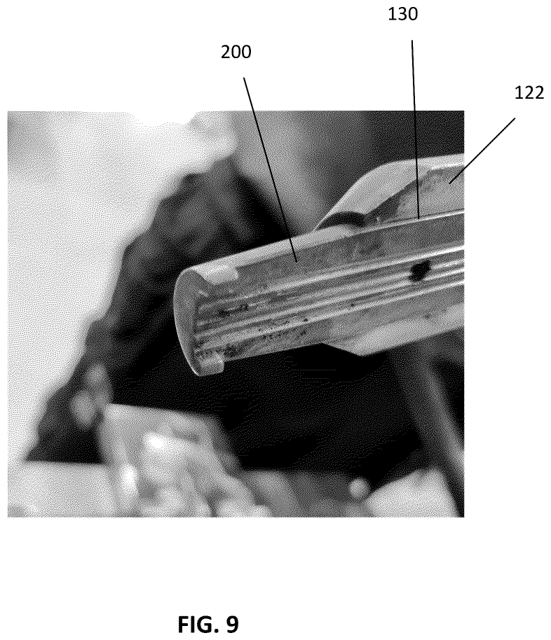

FIG. 9 is a perspective view of a portion of contact jaw 200 coupled to contact bracket 122. As shown, contact bracket 122 includes a receptacle 130 formed therein that receives the contact jaw 200.

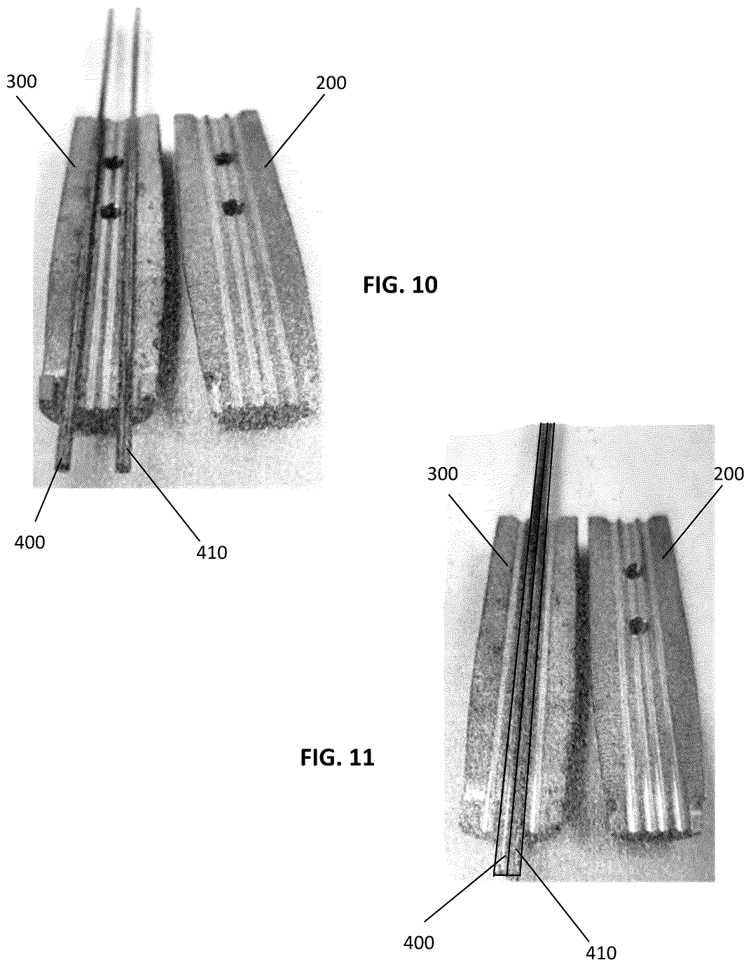

Referring to FIGS. 10 and 11, perspective views of the contact jaws 200 and 300 with welding wires 400 and 410 in different configurations are illustrated. Turning to FIG. 10, welding wires 400 and 410 are placed in the outer pair of grooves 360 and 366, which correspond to passageways 380 and 386, respectively. In this arrangement, the welding wires 400 and 410 are in spaced apart position configuration, in which the wires 400 and 410 are in a twin mode for welding. In FIG. 11, welding wires 400 and 410 are placed in the inner pair of grooves 362 and 364, which correspond to passageways 382 and 384, respectively. In this configuration, the welding wires 400 and 410 are adjacent to and contacting each other, which results in the wires 400 and 410 functioning as a single wire in a force single mode of welding.

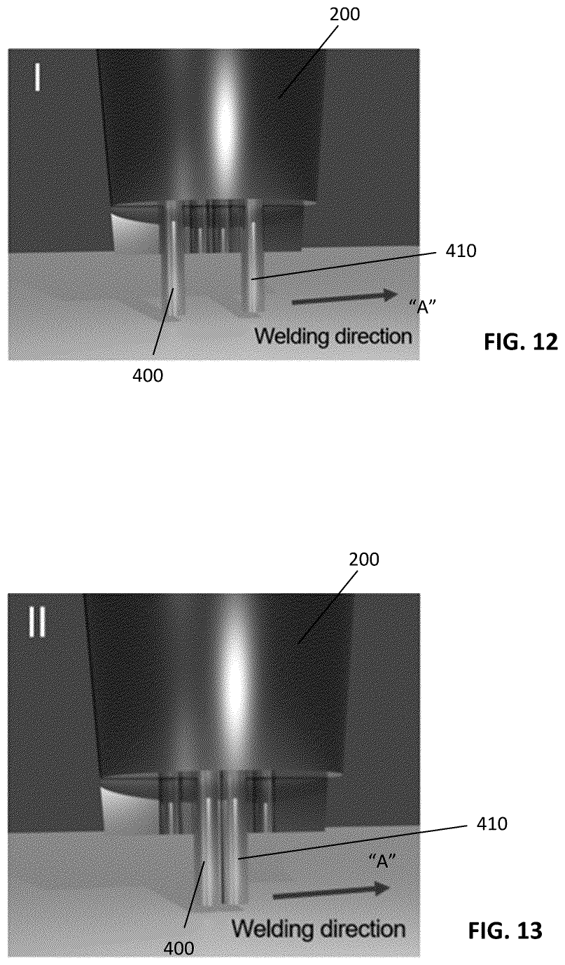

Turning to FIGS. 12 and 13, close-up front views of the contact jaws with welding wires are illustrated in two different configurations. The adaptive twin SAW contact jaws can be quickly configured between two or more operating modes or configurations. In FIG. 12, the contact jaws and wires 400 and 410 are in a normal twin mode, and in FIG. 13, the contact jaws and wires 400 and 410 are in a “force single” mode. In the twin mode, the welding head is operating in a conventional twin SAW operation. In the force single mode, the two wires are set in close contact with one another with substantially the same parameters as a single wire SAW operation (e.g., low current) to create a weld bead (e.g., a root weld bead) that is substantially similar to a weld bead formed with conventional single wire SAW. In the force single mode, the wires 400 and 410 are in contact sharing the current. In the twin mode, the current follows the path of least resistance which makes the current jump in between the wires, back and forth.

In operation, a root pass may be performed with the torch head arranged in the force single mode in which the wires 400 and 410 are in passageways 382 and 384. After the root pass, the torch head may be quickly rearranged into the twin SAW mode by separating the wires for subsequent passes along the weld seam. This rearrangement involves moving the wires 400 and 410 to passageways 380 and 386. In the twin SAW mode, the welding head may be operated as a conventional twin SAW, increasing the deposition rate. Consequently, the adaptive twin jaws can be quickly changed between both operating modes to reduce downtime and increase productivity.

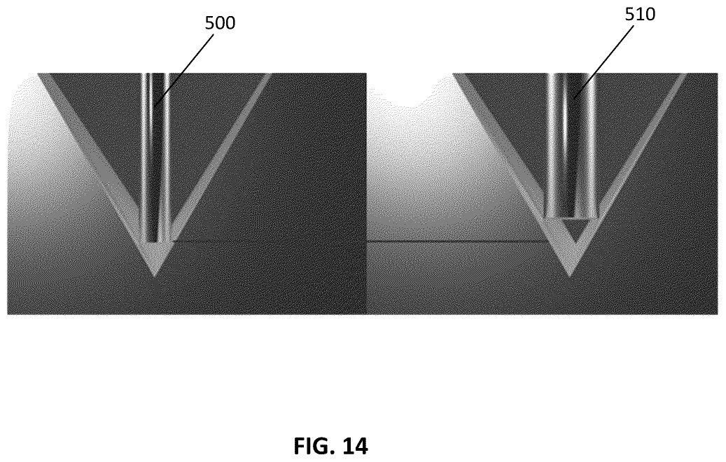

FIG. 14 illustrates views showing the relative depths that a pair of welding wires and a single wire can achieve. The wire shown on the left of FIG. 14 is a side view of two welding wires 500 in line with or aligned with each other in the force single mode. In this example, each of the two wires has a diameter of 2.0 mm. The wires being in line with each other enables them to extend into a groove the distance shown because of the orientation of the groove and the wires. However, a single wire 510 having a diameter of 4.0 mm, which is equivalent to the combined diameter of the 2.0 mm diameter wires 500 cannot extend as far into the groove for the welding process. The perimeter length of the combined wires 500 is large in relation to the cross-section area of the wires 500. This is beneficial because the combined wires 500 are capable of handling high currents. In turn, this creates a large process window, e.g., a window of approximately 850 Amps, such as from approximately 250 Amps to 1,100 Amps, that allows users to operate with a wide variety of power sources and/or in a wide variety of environments. This may also allow welding operations to be more efficient, since the welding operation can utilize relatively low power forced single welding to create a root pass before using high deposition twin operations, while avoiding high power operations that are often required for welding operations to try to achieve similar penetration and deposition with a single welding arrangement. In addition, the two smaller diameter wires 500 can reach deeper into the groove than a thicker wire 500, thereby ensuring better penetration. This is because two smaller wires have a smaller width dimension that a single wire with a diameter that is equivalent in size to the combined length of two single wires.

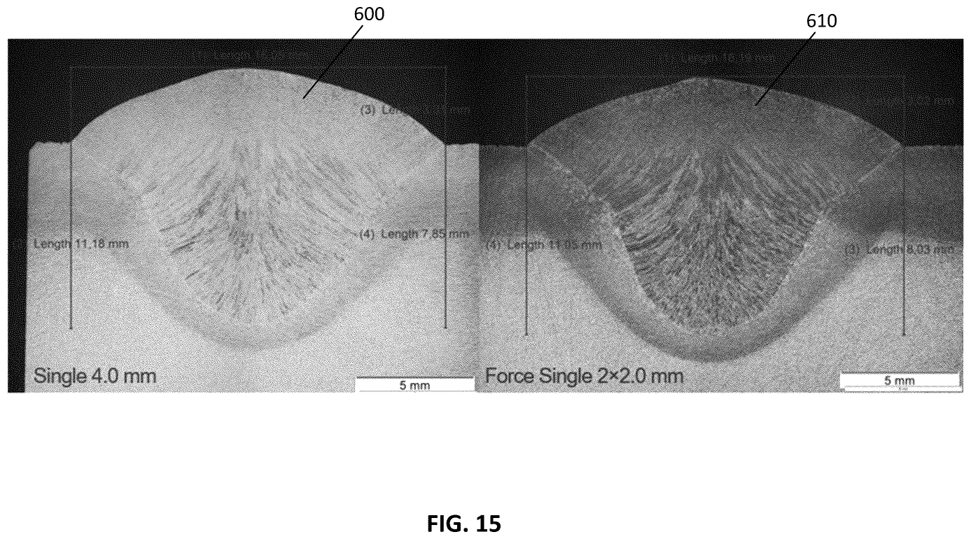

FIG. 15 illustrates images from bead on plate testing of a single 4.0 mm wire compared to two 2.0 mm wires used according to the present invention. Both tests were run with the same parameters: 700A and 29V. In FIG. 15, the left photo shows a bead 600 from using a single 4.0 mm wire and the right photo shows a bead 610 from using the adaptive twin contact jaws of the present invention in a force single mode or configuration in which two 2.0 mm wires are proximate each other in the inner grooves of the contact jaws. The adaptive twin result has a 9% higher deposition rate in this example, and produces a bead geometry that is indistinguishable from the single 4.0 mm wire. If anything, the bead 610 achieves slightly more penetration than bead 600, which is desirable.

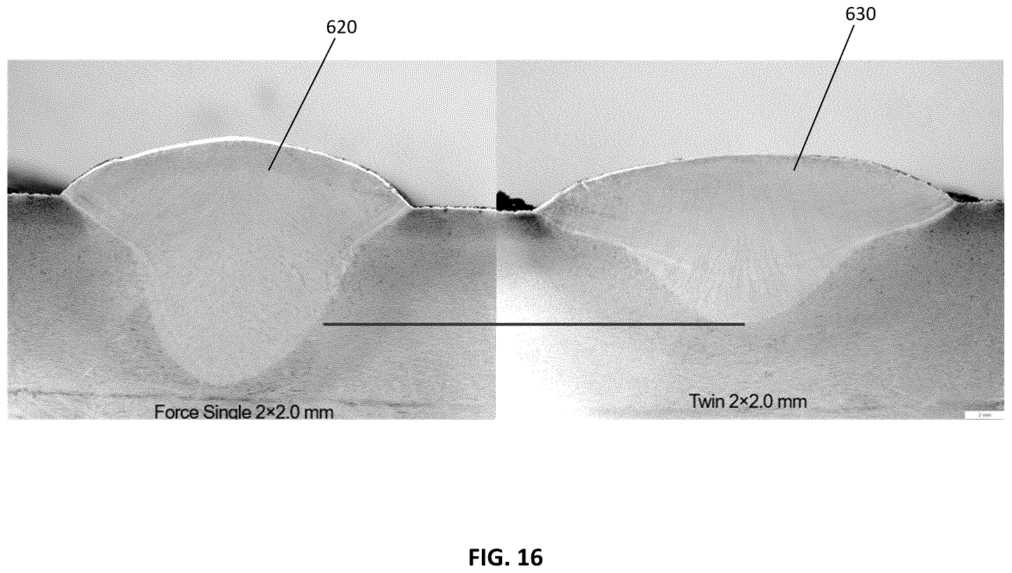

FIG. 16 illustrates another example relating to the present invention. Both of the welds in FIG. 16 were welded at 700 A, 32V, and 55 cm/min. Bead 620 is the result of using the adaptive twin contact jaws is the force single mode or configuration with two 2.0 mm diameter wires. Bead 630 is the result of using the adaptive twin contact jaws is the twin mode or configuration with two 2.0 mm diameter wires. As shown the force single has superior penetration.

The adaptive twin system of the invention provides the benefits of penetration and root-run capabilities of the single wire mode and the high productivity of the twin wire mode. Changing between the force single mode and the twin mode is easy and involves loosening the fastener 124 and/or 125 so the user can move the contact bracket 122 and contact jaw 200 away from contact jaw 300 enough so the user can move the welding wires 400 and 410 from the twin configuration of grooves 260 and 360 and grooves 266 and 366 to the force single configuration of grooves 262 and 362 and grooves 264 and 364, or the reverse movement from the force single configuration to the twin configuration.

The first and second contact jaws 200 and 300 may be manufactured from any appropriate conductive material now known or hereafter developed, including, for example, a high strength, temperature resistant copper alloy. In one embodiment, the first and second contact jaws 200 and 300 may operate at a temperature below 3000 Celsius (e.g., below the softening temperature of the high strength, temperature resistant cooper alloy). By manufacturing the contact jaws from a high strength copper, concerns that the jaws may melt or easily deform if they are made too thin, subside. In one embodiment, the first and second contact jaws may be made from a material having a yield strength of approximately 300-400 MPa.

In an alternative embodiment, the contact jaws 200 and 300 may be operated in twin SAW mode with a welding wire in one of the inner passageways 382 or 384 and another welding wire in one of the outer passageways 380 and 386 to adjust the relative distances between the wires. In another alternative embodiment, the contact jaws 200 and 300 includes only three grooves, and only one welding wire is rearranged between an inner groove and outer groove to switch between the force single mode and the twin SAW mode. While the welding process has been described above relative to SAW, other welding processes (e.g., GMAW, cladding, etc.) using consumable wires may be performed with the adaptive twin consumable contact jaws.

As used herein, an element or step recited in the singular and proceeded with the word “a” or “an” should be understood as not excluding plural elements or steps, unless such exclusion is explicitly recited. Furthermore, references to “an embodiment” or “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

What is claimed is:

1. A contact device for providing current to at least a first welding wire and a second welding wire, the contact device comprising:
a first contact jaw having an inner surface defining a plurality of grooves; and
a second contact jaw, wherein the plurality of grooves of the first contact jaw includes a first pair of grooves and a second pair of grooves different from the first pair of grooves, and each of the plurality of grooves on the first contact jaw is sized so that it can receive a welding wire.

2. The contact device of claim 1, wherein the second contact jaw has an inner surface defining a plurality of grooves, and each of the grooves of the second contact jaw being aligned with one of the grooves of the first contact jaw when the first contact jaw inner surface is proximate to the second contact jaw inner surface.

3. The contact device of claim 1, wherein the grooves in the first pair of grooves on the first contact jaw are proximate to each other.

4. The contact device of claim 3, wherein the first pair of grooves on the first contact jaw is located between the second pair of grooves on the first contact jaw.

5. The contact device of claim 1, wherein each of the grooves in the second pair of grooves on the first contact jaw is spaced a first distance from an outer side surface of the first contact jaw, each of the grooves in the first pair of grooves is spaced a second distance from an outer surface of the first contact jaw, and the first distance is smaller than the second distance.

6. The contact device of claim 1, wherein the first contact jaw includes a first end and a second end opposite to its first end, each of the grooves in the first contact jaw extends from the first contact jaw first end to the first contact jaw second end, the first pair of grooves in the first contact jaw are an inner pair of grooves, the second pair of grooves in the first contact jaw are an outer pair of grooves, and the inner pair of grooves are located between the outer pair of grooves.

7. The contact device of claim 6, wherein the first contact jaw includes a plurality of tapered surfaces formed in its first end, the plurality of tapered surfaces include a first tapered surface in communication with a first groove of the outer pair of grooves, a second tapered surface in communication with a second groove of the outer pair of grooves, and a third tapered surface in communication with both grooves of the inner pair of grooves.

8. The contact device of claim 1, wherein the first contact jaw includes a notch formed therein, the second contact jaw includes a projection extending therefrom, and the projection engages the notch when the first contact jaw is proximate to the second contact jaw.

9. A contact device for providing current to a first welding wire and a second welding wire, the contact device having a first operating configuration and a second operating configuration different from the first operating configuration, the contact device comprising:
a first contact jaw having an inner surface defining a first pair of grooves and a second pair of grooves; and
a second contact jaw having an inner surface defining a first pair of grooves and a second pair of grooves, wherein when the inner surface of the first contact jaw is proximate to the inner surface of the second contact jaw, the first pairs of grooves are aligned with each other and form a first pair of passageways along the first contact jaw and the second contact jaw, and the second pairs of grooves are aligned with each other and form a second pair of passageways along the first contact jaw and the second contact jaw, and in the first operating configuration the first welding wire and the second welding wire are disposed in the first pair of passageways, and in the second operating configuration the first welding wire and the second welding wire are disposed in the second pair of passageways.

10. The contact device of claim 9, wherein the passageways in the first pair of passageways are proximate to each other.

11. The contact device of claim 9, wherein the passageways in the first pair of passageways are located between the passageways in the second pair of passageways.

12. The contact device of claim 9, wherein each of the passageways in the second pair of passageways is spaced a first distance from an outer side surface of the contact jaws, each of the passageways in the first pair of passageways is spaced a second distance from an outer side surface of the contact jaws, and the first distance is smaller than the second distance.

13. The contact device of claim 9, wherein the grooves in the first contact jaw are parallel to each other and extend from a first end of the first contact jaw to a second end of the first contact jaw, the grooves in the second contact jaw are parallel to each other and extend from a first end of the second contact jaw to a second end of the second contact jaw, and each of the grooves in the first contact jaw is aligned with one of the grooves in the second contact jaw when the first contact jaw and the second contact jaw are proximate to each other.

14. The contact device of claim 9, wherein the first welding wire and the second welding wire can be moved from the first pair of passageways to the second pair of passageways when the first contact jaw is spaced apart from the second contact jaw.

15. The contact device of claim 9, wherein the first welding wire and the second welding wire are adjacent to and contact each other when they are in the first pair of passageways in the first operating configuration.

16. A method of welding using a contact device for providing current to a first welding wire and a second welding wire, the contact device including a first contact jaw and a second contact jaw, the first contact jaw and the second contact jaw defining therebetween a first pair of passageways and a second pair of passageways, the contact device having a first operating configuration and a second operating configuration, the method comprising:
placing the contact device in the first operating configuration;
providing current to the first welding wire and the second welding wire;
moving the first contact jaw away from the second contact jaw to access the first welding wire and the second welding wire;
placing the contact device in the second operating configuration; and
providing current to the first welding wire and the second welding wire.

17. The method of claim 16, wherein the step of placing the contact device in the first operating configuration includes positioning the first welding wire and the second welding wire in the first pair of passageways.

18. The method of claim 16, wherein the step of placing the contact device in the second operating configuration includes moving both of the first welding wire and the second welding wire to the second pair of passageways.

19. The method of claim 16, wherein the placing the contact device in the first operating configuration results in the first welding wire and the second welding wire being proximate to and contacting each other.

20. The method of claim 19, wherein the placing the contact device in the second operating configuration results in the first welding wire and the second welding wire being spaced apart from each other.
